(19) United States
(12) Patent Application Publication
(10) Pub. No.: US 2025/0069305 A1
(43) Pub. Date: Feb. 27, 2025

(54) METHOD FOR AN AUTOMATED GENERATION OF SYNTHETIC SCENES

(71) Applicants: ROBERT BOSCH GmbH, Stuttgart (DE); CARIAD SE, Wolfsburg (DE)

(72) Inventors: Julio Borges, Stuttgart (DE); Kevin Alexander Laube, Rottenburg Am Neckar (DE); Praveen Anil Kulkarni, Bengaluru (IN)

(21) Appl. No.: 18/810,251

(22) Filed: Aug. 20, 2024

(30) Foreign Application Priority Data
Aug. 24, 2023 (DE) 10 2023 122 675.4

(51) Int. Cl. G06T 11/60; G06T 19/20

(52) U.S. Cl. CPC G06T 11/60; G06T 19/20; G06T 2219/2004

(57) ABSTRACT

The invention relates to a method (100) for an automated generation of synthetic scenes (175), comprising the following steps:
providing (101) scene data (110) representing a plurality of template scenes (120),
providing (102) object data (115) specifying various objects (125) for insertion into the synthetic scene (175),
providing (103) at least one scene parameter (130) for the template scenes (120), which describes at least one characteristic of the template scenes (120),
generating (106) intermediate representations (140) for the synthetic scenes (175), wherein, regarding the intermediate representations (140), at least one selected object (125) is in each case inserted into a selected template scene (120), wherein the insertion of the at least one selected object (125) is parametrized based on the provided scene parameter (130) in order to account for physical plausibility in the respective intermediate representation (140),
determining (107) conditioning data (150) from the generated intermediate representations (140) in order to also account for physical plausibility in the synthetic scenes (175),
initiating (108) the generation of the synthetic scenes (175) based on the determined conditioning data (150).

The invention relates to a method for an automated generation of synthetic scenes. The invention further relates to a computer program, a device, and a storage medium for this purpose.

### PRIOR ART

Generative models, such as GANs or diffusion models, are increasingly being used to generate photorealistic synthetic images that can be used for model training or validation. The integration of “rare” objects into synthetic scenes is useful in areas such as autonomous driving in order to, e.g., account for an inoperative motorcycle in the middle of the road. However, the acquisition of such rare scenarios is quite difficult, so their generation by means of generative models becomes a significant task.

What is referred to as “inpainting” is known from the prior art. In text-image diffusion models in particular, inpainting is possible by selecting a binary mask that describes an area into which the object should be inserted. The object can then be described by a text prompt (see, e.g., Rombach, Robin, et al. “High-resolution image synthesis with latent diffusion models.” Proceedings of the IEEE/CVF Conference on Computer Vision and Pattern Recognition. 2022). However, the disadvantage of this situation is often the lack of control over how the desired object is generated. The use of a single text prompt and a mask allows the generative model too much freedom when performing the inpainting. As a result, the desired object is often not generated in a sufficiently realistic manner.

Related research has specialized in defining shape masks for improved control object placement (see, e.g., Xie, Shaoan, et al. “SmartBrush: Text and Shape Guided Object Inpainting with Diffusion Model.” arXiv preprint arXiv: 2212.05034, 2022).

An additional challenge and limitation of conventional methods is that of automation. For example, if “an inoperative motorcycle on the road” is intended to be inserted, then the size, orientation, position, and other characteristics of the motorcycle must be established in the original scene. This ensures that the motorcycle remains physically plausible when inserted, without the need for human intervention. The automation of such a process raises a number of complex issues that have not yet been addressed, or at least not sufficiently, particularly with respect to the industrialization of these approaches.

### DESCRIPTION OF THE INVENTION

The invention relates to a method having the features of claim 1, a computer program having the features of claim 8, a device having the features of claim 9, as well as a computer-readable storage medium having the features of claim 10. Further features and details of the invention follow from the dependent claims, the description, and the drawings. In this context, features and details which are described in connection with the method according to the invention are clearly also applicable in connection with the computer program according to the invention, the device according to the invention, as well as the computer-readable storage medium according to the invention, and respectively vice versa, so mutual reference is always made or may be made with respect to the individual aspects of the invention.

The invention relates in particular to a method for an automated generation of synthetic scenes, comprising the following steps:
providing scene data representing a plurality of template scenes,
providing object data specifying various objects—in particular for insertion into the synthetic scene,
providing at least one scene parameter for the template scenes, which describes at least one characteristic of the template scenes,
generating intermediate representations for the synthetic scenes, whereby, regarding the intermediate representations, at least one selected object is in each case inserted into a selected template scene, the insertion of the at least one selected object being parametrized based on the provided scene parameter in order to account for physical plausibility in the respective intermediate representation,
determining conditioning data from the generated intermediate representations in order to also account for physical plausibility in the synthetic scenes,
initiating the generation of the synthetic scenes based on the determined conditioning data, in particular by means of a generative (machine learning) model.

The invention provides an improved solution for the automated insertion of objects into a synthetic scene, and in particular aims to improve the generation of synthetic scenes and make them more realistic, efficient, and versatile.

Hereinafter, the task of inserting an object into a scene, preferably a template scene, is also referred to as “inpainting”. The scene can in this case be a synthetic or a real scene, and/or based on a simulated and/or a real scene. In addition, a scene can be described by scene parameters such as Canny edge representations, depth maps, semantic label maps, or a combination thereof.

Generative models have the ability to create realistic-looking images which represent synthetic scenes. The advantage is that the image generation process can be controlled so as to “place” (paint in) a desired object (e.g., an inoperative motorcycle in the middle of the road) into the scene. The shape, position, and orientation of the placed object can thereby be controlled, and the placement can be both adapted to the environment around the image and be physically plausible, e.g. in terms of size and distance. A further advantage is that this process can be automated, so no human input is absolutely necessary. In particular, this serves to achieve the specific task of generating a synthetic image with and/or without a desired object being painted into the synthetic scene (instead of altering a real image). “Semantic image synthesis” is one possible method for achieving this task, in particular when using GANs (GAN is the abbreviation for “Generative Adversarial Network”). A scene can in this case be described by a semantic label map. For inpainting, objects can then be painted in by manipulating the semantic label map. Optionally, however, only objects such as those described by the limited number of classes in the semantic label map can be inpainted. In contrast, the solution proposed according to the invention can have the ability to automatically introduce objects into the desired synthetic scenes without this restriction and, in this way, generate a plurality of images comprising the desired inpainted objects.

As another option, it can be provided that the synthetic scenes are generated by a generative model, preferably by a diffusion model. This machine learning model can generate the synthetic scenes based on a scene definition, preferably a text prompt, and preferably using at least one of the objects according to the object data. The generation can in this case be conditioned by the conditioning data, whereby the conditioning data are preferably used for this purpose when training the model in order to influence the model output. The generation of synthetic images via conditional inputs can in this way be conditioned and thus improved, e.g. using the scene parameters. The generative model can also be designed as a text-image diffusion model, e.g. stable diffusion. For example, ControlNet can then control the model outputs by processing the conditioning data and using this information to influence the model outputs. The text request can also be referred to as a text prompt and, e.g., comprise the (optionally complete) description of the desired scene (e.g., the environment and the desired objects in the scene) in text form.

Within the scope of the invention, it is conceivable that the provided scene parameter comprises at least depth maps, and/or semantic label maps, and/or a Canny edge representation for use in the automated determination of a position, and/or orientation, and/or size of the objects for insertion into the template scenes. This enables a physically plausible insertion into the template scene. It is also possible that the provided scene parameter alternatively or additionally comprises at least one of the following parameters for describing a scene: Normal Maps, Soft Edges, M-LSD straight lines, Scribbles, OpenPose.

For example, it can be provided that the physical plausibility for the intermediate representation is taken into account and maintained at least in that the insertion of the at least one selected object is parameterized with respect to a position of the object using the provided scene parameter, preferably in order to determine a spatial placement of the object in the template scene as a function of a driving situation and/or an environment of the template scenes. This optionally enables a fully automated, and thus more efficient, generation of synthetic scenes, e.g. for training a machine learning model.

It can furthermore be provided the object data comprise at least one dataset having the various objects, whereby the objects comprise at least tires and motorcycles, and the at least one dataset provides each of the objects in two-dimensional form as a 2D image, and/or in three-dimensional form as a 3D model, in which case the 3D models differ from one another with respect to their parametrization of a dimension, and/or an angle, and/or a pose, and/or an orientation. A plurality of scene variants can be generated in order to, e.g., enable comprehensive training of a machine learning model based on the synthetic scenes.

Within the scope of the invention, it is also optionally possible that the template scenes comprise a plurality of artificial and/or real driving scenes for autonomous driving, the synthetic scenes comprising multiple artificial driving scenes which are generated in reference to the determined conditioning data, in particular through an influence on weighting parameters of a generative model, such that information about the inserted object and preferably about a layout of the respective intermediate representation is taken into account, whereby training data for training a machine learning model for autonomous driving are preferably provided based on the generated synthetic scenes. It is possible that the machine learning model trained in this way will be used in a vehicle. The vehicle can, e.g., be designed as a motor vehicle, and/or passenger vehicle, and/or autonomous vehicle. The vehicle can comprise a vehicle arrangement for, e.g., providing an autonomous driving function and/or a driver assistance system. The vehicle arrangement can be designed to control the vehicle in an at least partially automated manner, and/or accelerate, and/or brake, and/or steer the vehicle.

For example, ControlNet can use the generative model, e.g. Stable Diffusion, and, by influencing or changing the weighting parameters for the model, influence how information about the layout—which cannot otherwise be taken into account by Stable Diffusion—can also be taken into account. Synthetic images can thus generated using the synthetic scenes, which feature greater quality due to greater physical plausibility.

It can also be possible for the determination of the conditioning data from the generated intermediate representations to comprise at least the following step:
extracting at least one scene parameter from the respective intermediate representation, preferably a Canny edge representation which comprises edges from the template scene and the inserted object. By using the intermediate representation, the important conditioning data can thus be generated for final synthetic image generation. For example, a Canny edge containing edges from both the original source image and the integrated object can be used as a guide for synthesizing a new image by means of stable diffusion. This enables improved synthesization of physically plausible scenes. The intermediate representation can also be referred to as a synthetic intermediate image.

The invention further relates to a computer program, in particular a computer program product comprising instructions that, when the computer program is executed by a computer, prompt the latter to perform the method according to the invention. The computer program according to the invention thereby provides the same advantages as described in detail with regard to a method according to the invention.

The invention further relates to a device for data processing, which is configured to perform the method according to the invention. For example, a computer can be provided as the device which executes the computer program according to the invention. The computer can comprise at least one processor for executing the computer program. A non-volatile data storage means can also be provided, in which the computer program is stored and from which the computer program can be read by the processor for execution.

The invention further relates to a computer-readable storage medium comprising the computer program according to the invention and/or comprising instructions that, when executed by a computer, prompt the latter to perform the method according to the invention. The storage medium is, e.g., designed as a data storage means such as a hard disk, and/or a non-volatile memory, and/or a memory card. The storage medium can, e.g., be integrated into the computer.

The method according to the invention can furthermore be designed as a computer-implemented method.

Further advantages, features, and details of the invention follow from the description hereinafter, in which embodiments of the invention are described in detail with reference to the drawings. In this context, each of the features mentioned in the claims and in the description may be essential to the invention, whether on their own or in any combination. Shown are:

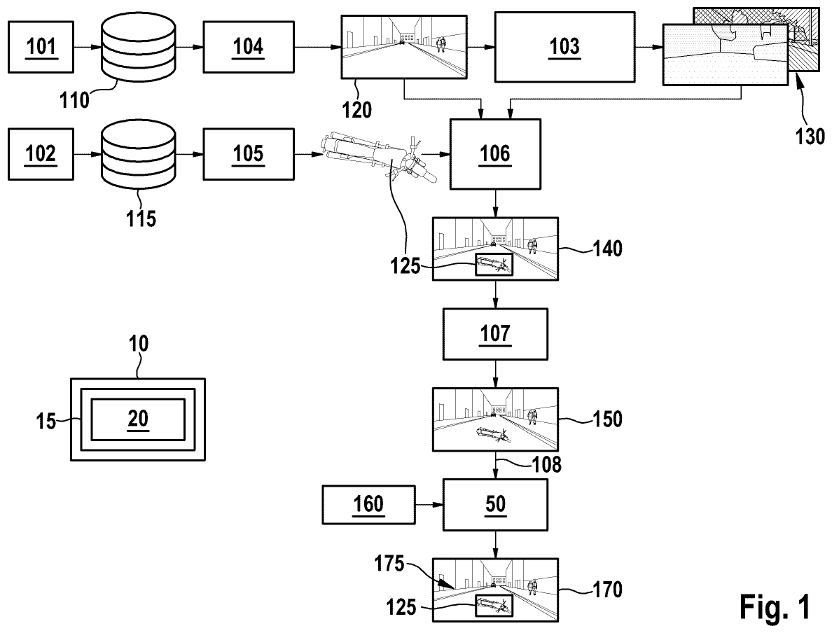

FIG. 1 a schematic illustration of a method, a device, a storage medium, as well as a computer program according to exemplary embodiments of the invention.

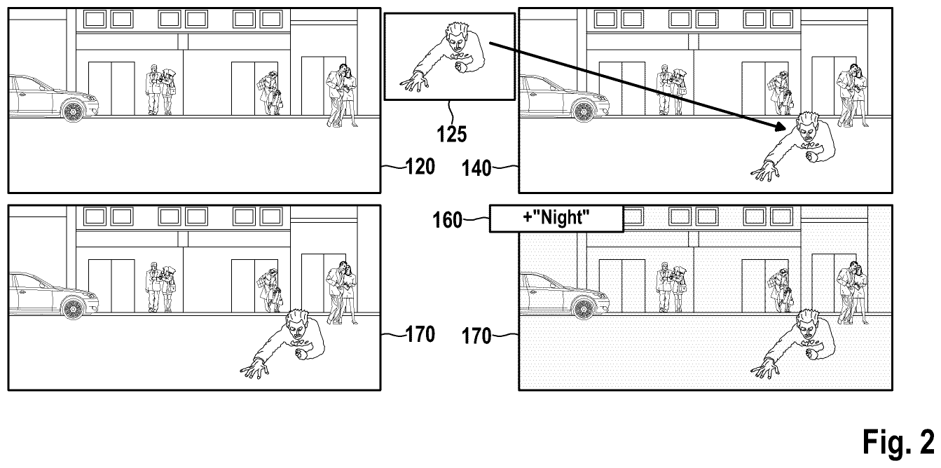

FIG. 2 a schematic representation of synthetic images and the conditioning data.

Schematically shown in FIG. 1 are a method 100, a device 10, a storage medium 15, as well as a computer program 20 according to exemplary embodiments of the invention. FIG. 1 illustrates a method 100 for an automated generation of synthetic scenes 175 according to exemplary embodiments of the invention. Provided according to a first method step 101 are scene data 110, which can represent a plurality of template scenes 120. The scene data 110 can be provided digitally, e.g. by an interface of a computer program. Provided according to a second method step 102 are object data 115, which can specify various objects 125 for insertion into the synthetic scene 175. The object data 115 can in this case be datasets that specify the objects 125 that are intended to be provided in the subsequent synthetic scene 175. In a third method step 103, at least one scene parameter 130 can be provided for the template scenes 120 and describe at least one characteristic of the template scenes 120. According to a fourth method step 104, at least one of the template scenes 120 can then be selected, and at least one of the objects 125 can be selected according to a fifth method step 105. This selection can optionally be performed in an automated and/or random manner. In addition, a generation of intermediate representations 140 for the synthetic scenes 175 can be provided in a sixth method step 106. Regarding the intermediate representations 140, at least one selected object 125 can in each case be inserted into a selected template scene 120. The insertion of the at least one selected object 125 can in this case be parametrized based on the provided scene parameter 130 in order to take into account a physical plausibility of the respective intermediate representation 140. According to a seventh method step 107, conditioning data 150 can be determined from the generated intermediate representations 140 in order to also account for physical plausibility in the synthetic scenes 175. In an eighth method step 108, the generation of the synthetic scenes 175 can then be initiated based on the determined conditioning data 150. In this case, the previously selected objects 125 can in an advantageous manner be inserted into the scene 175 by means of a corresponding input in a text prompt.

Embodiments of the invention can be based on “ControlNet” a known method described in Zhang, Lvmin, and Maneesh Agrawala, “Adding conditional control to text-to-image diffusion models.” arXiv preprint arXiv: 2302.05543, 2023 beschrieben ist. Stable diffusion can in this case be used to create what is referred to as “rare object inpainting”. Stable Diffusion is a deep learning text-to-image generator and can be used to generate detailed images on the basis of text descriptions. ControlNet can be referred to as a neural network which is suitable for learning task-related conditions in an end-to-end manner.

Using ControlNet, it is possible to condition the generation of synthetic images 170 with Stable Diffusion via conditional inputs. The conditional inputs can, e.g., comprise Canny edges, and/or depth maps, and/or semantic label maps. These conditions can be extracted from a real image or from a simulation environment. However, there are cases in which the integration of additional objects 125 that were not originally present in the scene is desired. Embodiments of the invention address this need and provide an elegant and versatile solution for creating images that fit seamlessly into their environment, while also taking user-specific inclusions into account. ControlNet can in this case also be applied to a pretrained diffusion model and be enhanced by an input option for conditional inputs.

ControlNet uses scene descriptions, e.g. Canny edge representations, depth maps, semantic label maps, or a combination thereof, to control the generation of synthetic images 170. According to embodiments of the invention, this conditioning aspect 150 can be manipulated by integrating objects 125 into these conditions, e.g. Canny edges, in a plausible manner in order to ultimately create a synthetic yet realistic image which contains the desired object 125.

In embodiments of the invention, it can also be provided that depth maps and semantic label maps are available and are used for automatically determining the position, orientation, and size of objects. The need for human interventions in such tasks can be eliminated as a result. This approach thus paves the way for a more seamless, efficient, and scalable image generation process, which enables a higher level of customization and control over the final visual result.

The use of depth maps, semantic label maps, and Canny edge representation can be understood as a multimodal approach. Although this information comes from the same source (i.e., images), these scene parameters can represent various visual information aspects and provide supplemental information about the scene.

Depth maps provide, e.g., information about the distance or depth of objects in a scene in relation to the camera, while Canny edge detection can emphasize the edges or boundaries of objects in the image. Semantic label maps can represent the semantic category of each pixel in the image, which contributes to an understanding the objects 125 and their relationships within the scene. By combining these data types, it is possible to effectively fuse different representations of the same scene, which can improve the performance and controllability of a generative model 50 (in this case stable diffusion using ControlNet, by way of example) by providing more diverse and supplemental information.

Embodiments of the invention provide the ability to insert a desired object 125 into a synthetic scene 175. It can in this case be a prerequisite that a 2D or 3D be present, but without being limited to predefined classes, as is the case with semantic image synthesis. Furthermore, a high degree of control over the appearance of objects (e.g., position, angle (orientation), pose, etc.) is provided. This results in more realistic object insertions. Additionally, when annotations such as depth maps and semantic label maps are available, it can automatically be determined where the desired object 125 should be placed in a physically plausible manner, without requiring human intervention. Since no human intervention is required, image generation is more efficient and easier to scale.

Exemplary embodiments of the invention are in particular able to generate photorealistic images including rare objects, i.e. objects that are seen and collected quite rarely in the real world, in order to enrich (augment) the training and validation of autonomous driving systems. However, the recommended approach is not limited to this use case and can be used in any scenario in which inpainting is desired. In addition, the method 100 according to embodiments of the invention can be used to generate training data for automated training. Furthermore, embodiments of the invention feature an end-to-end approach to inpainting objects in a generative pipeline.

According to exemplary embodiments of the invention, the ControlNet architecture can be used to condition stable diffusion models for photorealistic synthetic image generation in general and for driving scenes in particular. By creating conditioned inputs containing the desired (rare) objects 125 when generating photorealistic images using ControlNet under these conditions, the objects 125 can be integrated (inpainted) into the scene in a natural manner. The best place and/or the best size, etc. for inserting the desired object 125 can thereby be calculated. The desired object 125 is in this way seamlessly blended into the environment, and the insertion appears realistic.

An optional fine tuning process can be provided first during training. Stable Diffusion (the basic model) may have been trained using an extensive collection of billions of images. In the meantime, ControlNet (the extension enabling conditional image generation) can be trained on various datasets which are tailored to the specific conditional inputs. When using Canny edge conditioning, ControlNet may have been fine-tuned to a set of, e.g., three million edge-image pairs.

According to exemplary embodiments of the invention, ControlNet can be trained on a dataset specific to the intended use case (e.g., autonomous driving). It can in this way be ensured that the synthetic image generation is better tuned to the target area.

Regarding inference, it can be assumed (for example) that an extensive dataset comprising target scenes (driving scenes) is present and is intended to be improved upon by means of synthetic data enhancement. Using this enrichment, new objects 125 can be inserted into the scene, thereby changing the composition of the scene. This dataset can comprise real-world images, or it can be derived from simulation environments like CARLA.

Regarding object selection, it can be assumed that a dataset exists which comprises various objects of interest that are intended to be integrated into various scenes. These objects may include, but are not limited to, tires, motorcycles, etc. The dataset can comprise 2D images or 3D-models. The 3D models can also come from platforms such as blenders, thus providing the ability to precisely manipulate dimensions, angles, poses, and orientations. Such adaptations make the inserted objects 125 appear more physically plausible within their respective scenes.

Regarding object insertion, after selecting the source image, the selected object 125 can be seamlessly integrated by means of an overlay technique such that a composite intermediate image 140 is formed (see FIG. 1 for a corresponding visual representation).

Physical plausibility should be ensured when responding to requests such as “insert an inoperative motorcycle in the middle of the road 20 meters away from the ego vehicle”. This can be achieved by using two components: (1) a semantic label map annotation and (2) a depth map which can be extracted from the source image via an inference network. The camera parameters in the depth map enable the calculation of the distance from the camera (or from the ego vehicle in the use case described) for each pixel in the image. The object 125 can then be positioned at the desired distance, e.g. 20 meters away from the ego vehicle. Since the distance is known, the size of the object 125 can be determined automatically in order to maintain physical plausibility.

Since the distance information can be known via the depth map (and the distance from the camera can be queried for each pixel in the image), it is possible to automatically recognize the ideal placement of the desired object 125 (e.g., in the middle of the road) by querying the semantic label maps that provide the class (e.g., the road) for each pixel in the image. The orientation and position of the object 125 can be either predefined or randomly selected, depending on the specific scene requirements.

In addition, information about the location of the object 125, e.g. 2D and 3D bounding boxes, can be determined and included in the output. These data may be important because these images are optionally used for subsequent object detection tasks, for which knowledge (annotation) regarding the object positions is required.

With regard to a further conditioning extraction step, the important conditioning data 150 for final synthetic image generation can be generated using the intermediate image 140 generated during the previous phase. For example, a Canny edge containing edges from both the template scene 120 (in particular the original source image) and the integrated object 125 can be used as a guide for synthesizing a new image by means of stable diffusion.

ControlNet can be compatible with a variety of conditions, including scene parameters such as Canny edges, Hough lines, human key points, segmentation maps, shape normals, depths, and others. These conditions can either be extracted from the image pool or already be provided in the form of labels. By taking such diverse inputs into account, ControlNet offers a versatile and comprehensive solution for refining and enriching driving scenes, paving the way for more accurate and visually pleasing synthetic image generation. Since stable diffusion operates in a text-to-image mode, additional conditioning examples can be provided via text prompts such as “snow” or “night” in order to further refine the desired synthetic image 170.

In a further step for generating a synthetic image 170, the conditioning information (Canny edge/semantic label map/depth map/etc.) from the previous step can be provided as input to the diffusion process along with an edited or predefined text prompt. The result can then be a synthetic image 170 comprising the desired scene and an integrated object 125. FIG. 2 shows, by way of example, results of the proposed pipeline by indicating a person creeping into a driving scene. This shows how text prompts may also affect the image generation of the synthetic image 170 (so that a night scene is created). Also shown are conditioning data 150 which may have been extracted from an intermediate representation 140.

The foregoing explanation of the embodiments describes the present invention only by way of examples. Insofar as technically advantageous, specific features of the embodiments may obviously be combined at will with one another without departing from the scope of the present invention.

1. A method for an automated generation of synthetic scenes, comprising the following steps:
providing scene data representing a plurality of template scenes,
providing object data specifying various objects for insertion into the synthetic scene,
providing at least one scene parameter for the template scenes, which describes at least one characteristic of the template scenes,
generating intermediate representations for the synthetic scenes, wherein, regarding the intermediate representations, at least one selected object is in each case inserted into a selected template scene, wherein the insertion of the at least one selected object is parameterized based on the provided scene parameter in order to account for physical plausibility in the respective intermediate representation,
determining conditioning data from the generated intermediate representations in order to also account for physical plausibility in the synthetic scenes,
initiating the generation of the synthetic scenes based on the determined conditioning data.

2. The method according to claim 1, characterized in that
the synthetic scenes are generated by a generative model, preferably by a diffusion model which generates the synthetic scenes based on a scene definition, preferably a text prompt, wherein the generation is conditioned by the conditioning data, wherein the conditioning data are preferably used for this purpose during training of the model in order to influence the outputs of the model.

3. The method according to claim 1, characterized in that the provided scene parameter comprises at least depth map, and/or semantic label map, and/or Canny edge representation for use in automatically determining a position, and/or orientation, and/or size of the objects for insertion into the template scenes.

4. The method according to claim 1, characterized in
that the physical plausibility for the intermediate representation is taken into account and maintained at least in that the insertion of the at least one selected object is parameterized with respect to a position of the object using the provided scene parameter, preferably in order to determine a spatial placement of the object in the template scene as a function of a driving situation and/or an environment of the template scenes.

5. The method according to claim 1, characterized in
that the object data comprise at least one dataset having the various objects, wherein the objects comprise at least tires and motorcycles, wherein the at least one dataset provides each of the objects in two-dimensional form as a 2D image and/or in three-dimensional form as a 3D model, wherein the 3D models differ from one another with respect to their parameterization of a dimension, and/or an angle, and/or a pose, and/or an orientation.

6. The method according to claim 1,
characterized in that the template scenes comprise multiple artificial and/or real driving scenes for autonomous driving, wherein the synthetic scenes comprise multiple artificial driving scenes which are generated in reference to the determined conditioning data, in particular by an influence on weighting parameters of a generative model, such that information about the inserted object and preferably about a layout of the respective intermediate representation is taken into account, wherein training data are provided in order to train a machine learning model for autonomous driving based on the generated synthetic scenes.

7. The method according to claim 1,
characterized in that the determination of the conditioning data based on the generated intermediate representations comprises at least the following step:
extracting at least one scene parameter from the respective intermediate representation, preferably a Canny edge representation, which comprises edges from the template scene and the inserted object.

8. (canceled)

9. A device for data processing, which is configured to:
provide scene data representing a plurality of template scenes,
provide object data specifying various objects for insertion into the synthetic scene,
provide at least one scene parameter for the template scenes, which describes at least one characteristic of the template scenes,
generate intermediate representations for the synthetic scenes, wherein, regarding the intermediate representations, at least one selected object is in each case inserted into a selected template scene, wherein the insertion of the at least one selected object is parameterized based on the provided scene parameter in order to account for physical plausibility in the respective intermediate representation,
determine conditioning data from the generated intermediate representations in order to also account for physical plausibility in the synthetic scenes,
initiate the generation of the synthetic scenes based on the determined conditioning data.

10. A non-transitory computer-readable storage medium comprising instructions that, when executed by a computer, cause the computer to:
provide scene data representing a plurality of template scenes,
provide object data specifying various objects for insertion into the synthetic scene,
provide at least one scene parameter for the template scenes, which describes at least one characteristic of the template scenes,
generate intermediate representations for the synthetic scenes, wherein, regarding the intermediate representations, at least one selected object is in each case inserted into a selected template scene, wherein the insertion of the at least one selected object is parameterized based on the provided scene parameter in order to account for physical plausibility in the respective intermediate representation,
determine conditioning data from the generated intermediate representations in order to also account for physical plausibility in the synthetic scenes,
initiate the generation of the synthetic scenes based on the determined conditioning data.
